(19) United States
(12) Patent Application Publication
(10) Pub. No.: US 2012/0041828 A1
(43) Pub. Date: Feb. 16, 2012

(54) System and Method for Prominent Sponsorship Theme Rotation in a Joint-Sponsorship Website

(76) Inventor: Tsz-Tak Daniel Ho, Palo Alto, CA (US)

(21) Appl. No.: 13/206,540

(22) Filed: Aug. 10, 2011

Related U.S. Application Data
(60) Provisional application No. 61/372,473, filed on Aug. 11, 2010.

(51) Int. Cl. G06Q 30/00

(52) U.S. Cl. 705/14.73

(57) ABSTRACT

A system and a related method are disclosed for effective advertisement of sponsors among multiple (i.e. joint) sponsors in a joint-sponsorship website. In one example, each sponsor in a joint-sponsorship website presents itself as a “prominent” sponsor, or “most visible” sponsor to an equal number of visitors. In this example, if there are twenty sponsors for the joint-sponsorship website and one million visitors to the joint-sponsorship website, each sponsor can show its “prominent” sponsorship theme to fifty thousand visitors. In another example, “prominent” sponsorship themes may not be divided equally but weighted based on weighted advertising budgets of sponsors, which enables a sponsor with a higher weighting present more of its “prominent” sponsorship theme over other sponsors. The system can also track identifying information of a particular visitor and ensure a correct amount of “prominent” sponsorship theme showings for that visitor.

### FIELD OF THE INVENTION

The present invention generally relates to online advertising. In particular, some embodiments of the present invention relate to equal or weighted amount of focused, or “prominent” visibility of a particular sponsor among a multiple number of sponsors in a joint-sponsorship website. Furthermore, some embodiments of the present invention also relate to a prominent sponsorship theme rotation in an award-based cross promotion (ABCP) campaign in a joint-sponsorship website.

### BACKGROUND OF THE INVENTION

Numerous online (e.g. Internet) campaigns or promotion programs involve conferences, sweepstakes, and other venues which involve joint sponsorship of multiple business entities. For example, an IEEE conference may involve advertising or corporate image (CI)-based sponsorship by many electronics companies. In another example, an online joint sweepstakes campaign may involve several sponsor entities which may form an award-based cross promotions (ABCP). One advantage of a joint sponsorship is distributed sharing of the total cost for a campaign or a promotion program. However, a potential disadvantage of such a joint sponsorship concept is uneven visibility or visually-cluttered presentation of each sponsor in a joint sponsorship advertising.

The uneven visibility or visually-cluttered presentations may be a significant drawback for the effectiveness of joint sponsorship campaigns and joint sponsor-based promotion programs, because website viewers (e.g. attendants of a conference, jointly-sponsored sweepstake participants, and etc.) of such campaigns and promotion programs typically go through multiple web-page screens during a log-in and/or a registration process, and there are many opportunities potentially lost for effective advertising to each website viewer of joint sponsorship-based online campaigns and promotion programs.

A conventional presentation of joint sponsorship-based online campaigns and promotion programs involves one or more webpages showing a tabular list of all or a subset of sponsors, or one particular sponsor based on a randomized advertising presentation scheme. This conventional method often presents confusions (i.e. a visually-cluttered presentation, or too many information per advertising space) to a website viewer, in case of the tabular list of all sponsors, and uneven exposure of sponsors, in case of showing the subset of sponsors or just one particular sponsor to a website viewer.

Furthermore, in case of the subset presentation of multiple sponsors or one sponsor presentation among multiple sponsors to a website viewer, a conventional advertising system typically does not track how subsequent joint sponsor advertisements are presented in repeated visits by the same website viewer.

Therefore, it may be beneficial to create a system and a related method for presenting a plurality of multiple sponsors in more heuristic, focused, and effective ways on a joint-sponsorship website. Furthermore, it may also be beneficial to devise a procedure to track a particular website viewer for a fairly-distributed showing of one or more multiple sponsors in case of repeated visits to the joint-sponsorship website.

### SUMMARY

Summary and Abstract summarize some aspects of the present invention. Simplifications or omissions may have been made to avoid obscuring the purpose of the Summary or the Abstract. These simplifications or omissions are not intended to limit the scope of the present invention.

In one embodiment of the invention, a computerized system operating a prominent sponsorship theme rotation in a joint-sponsorship website is disclosed. This computerized system comprises a server machine operatively connected to a data network, wherein the server machine comprises a CPU, a memory unit, and an application program module comprising a sponsor identifying information decoder, a sponsorship theme selector, a page rendering engine, and a sponsor scheduler, wherein the application program module is executable on the CPU and the memory unit; a database operatively connected to the server machine, wherein the database is configured to store at least one of website-related, sponsor-related, and website visitor-related information; a sponsor selector operatively connected to or contained in the server machine, wherein the sponsor selector is capable of choosing a particular prominent sponsorship theme for a particular sponsor among a plurality of sponsors; and a website visitor's web browser operatively connected to the computer network.

Furthermore, in another embodiment of the invention, a method of enabling a prominent sponsorship theme rotation in a joint-sponsorship website is disclosed. This method comprises the steps of: taking a piece of sponsor identifying information in a sponsor identifying information decoder of an application program module executable on a CPU and a memory unit of a computerized system, wherein the sponsor identifying information decoder generates extracted information; and determining whether the extracted information from the sponsor identifying information decoder has a specified sponsor.

In addition, if the specified sponsor is found from the extracted information, this method further comprises the steps of: using a sponsorship theme selector of the application program module to generate a first prominent sponsor theme for the specified sponsor; rendering a first webpage which incorporates the first prominent sponsor theme for the specified sponsor; and presenting the first webpage to a web browser of the joint-sponsorship website. On the other hand, if the specified sponsor is not found from the extracted information, this method further comprises the steps of: using a sponsor scheduler and a sponsor selector of the application program module to select a particular sponsor; using the sponsorship theme selector of the application program module to generate a second prominent sponsor theme for the particular sponsor; rendering a second webpage which incorporates the second prominent sponsor theme for the particular sponsor; and presenting the second webpage to the web browser of the joint-sponsorship website.

### BRIEF DESCRIPTION OF DRAWINGS

FIG. 1 shows a conventional layout of presenting all multiple sponsors on a same webpage.

FIG. 2 shows another conventional layout of presenting only a subset of all multiple sponsors on a same webpage with a time slice rotation scheme.

FIG. 3 shows a screenshot from a prominent sponsorship theme rotation in a joint-sponsorship website, in accordance with an embodiment of the invention.

FIG. 4 shows a system architecture for a prominent sponsorship theme rotation in a joint-sponsorship website, in accordance with an embodiment of the invention.

FIG. 5 shows a sponsor identifying information (e.g. URL) decoder for a system operating a prominent sponsorship theme rotation in a joint-sponsorship website, in accordance with an embodiment of the invention.

FIG. 6 shows a flowchart for a page rendering engine of a system operating a prominent sponsorship theme rotation in a joint-sponsorship website, in accordance with an embodiment of the invention.

FIG. 7 shows a sponsor scheduler for a system operating a prominent sponsorship theme rotation in a joint-sponsorship website, in accordance with an embodiment of the invention.

FIG. 8 shows a sponsor scheduler flowchart for a system operating a prominent sponsorship theme rotation in a joint-sponsorship website, in accordance with an embodiment of the invention.

FIG. 9a shows a sponsor selector for a system operating a prominent sponsorship theme rotation in a joint-sponsorship website, in accordance with an embodiment of the invention.

FIG. 9b shows a sponsor selection module for a system operating a prominent sponsorship theme rotation in a joint-sponsorship website, in accordance with an embodiment of the invention.

FIG. 10a shows a graphical representation of a sponsor selection rotation module for a system operating a prominent sponsorship theme rotation in a joint-sponsorship website, in accordance with an embodiment of the invention.

FIG. 10b shows a weighted randomization module for a graphical representation of a sponsor selection rotation module, in accordance with an embodiment of the invention.

FIG. 11a shows a graphical representation of multiple visitors with weighted sponsor ratios for a sponsor selection rotation module used to display a prominent sponsorship theme of a particular sponsor to each visitor, in accordance with an embodiment of the invention.

FIG. 11b shows a graphical representation of multiple visitors with weighted sponsor ratios and randomization for a sponsor selection randomization module, which takes account of both weighted sponsor ratios and randomizations to display a prominent sponsorship theme of a particular sponsor to each visitor, in accordance with an embodiment of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

The detailed description is presented largely in terms of procedures, logic blocks, processing, and/or other symbolic representations that directly or indirectly resemble a system or a method for prominent sponsorship theme rotations in a joint-sponsorship website. These process descriptions and representations are the means used by those experienced or skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment. Furthermore, separate or alternative embodiments are not necessarily mutually exclusive of other embodiments. Moreover, the order of blocks in process flowcharts or diagrams representing one or more embodiments of the invention do not inherently indicate any particular order nor imply any limitations in the invention.

In general, embodiments of the invention relate to a system and a method for prominent sponsorship theme rotation in a joint-sponsorship website. Embodiments of the invention also relate to a procedure to track a particular website viewer for a fairly-distributed showing of one or more multiple sponsors in case of repeated visits to the joint-sponsorship website.

For the purpose of describing the invention, a term “prominent” is defined as a particularly-focused or particularly-visible condition of a sponsor's advertising campaign in a website. For example, a phrase “prominent sponsorship theme rotation” used in this Specification refers to a rotating theme of multiple sponsors for a prominent (i.e. particularly-focused or particularly-visible) exposure of one or more sponsors among all of the multiple sponsors, wherein the prominent exposure per sponsor takes turns according to the rotating theme.

Furthermore, for the purpose of describing the invention, a term “joint sponsorship” is defined as one or more promotion campaigns or advertising campaigns by a multiple number of business entities or institutions. One example of a joint sponsorship is a jointly-funded online conference with each sponsor having a chance to promote itself within a pool of multiple sponsors. Another example of a joint sponsorship is a sweepstakes campaign funded by a multiple number of sponsors, with each sponsor having an opportunity to promote itself within the sweepstakes campaign. A joint sponsorship-based sweepstake campaign may be considered to be an example of an award-based cross promotion (ABCP) among multiple sponsor entities.

In addition, for the purpose of describing the invention, a term “web browser” is defined as an application interface capable of displaying graphics, texts, and/or other information transmitted from a server or a computer to the application interface via a data network. This application interface called the “web browser” may be operating on a computer, a smart phone, or another electronic device. Some examples of “web browsers” include Internet Explorer, Firefox, Safari, and specialized mobile applications on a mobile device (e.g. a smart phone, a touchpad device, and etc.), which are capable of presenting graphics, texts and/or other information transmitted from a server or a computer via a data network such as the Internet.

Moreover, for the purpose of describing the invention, a term “webpage” is defined as information displayed on a display screen associated with the web browser, wherein at least some of the information includes graphics, texts, and/or other information transmitted from a server or a computer to the web browser via a data network.

Furthermore, for the purpose of describing the invention, a term “element” or “elements” are defined as graphics, texts, and/or other information which may be used and/or displayed on a webpage.

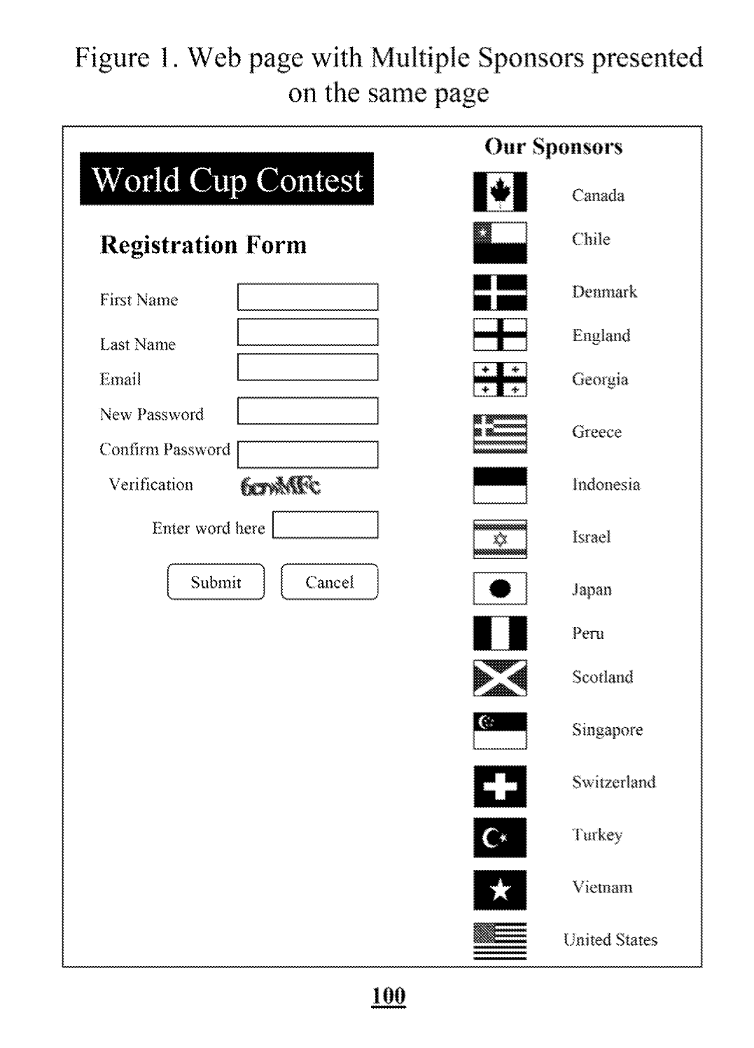

FIG. 1 shows a conventional layout (100) of presenting all multiple sponsors on a same webpage, in accordance with a conventional method. This conventional method illustrates how all multiple sponsors are presented in one webpage. The webpage is based on an example of a “World Cup Contest” registration for a website visitor. The visual heuristics, or effectiveness of the single-page web advertisement for many sponsors (e.g. 16 national sponsor teams presented in FIG. 1), is less than optimal because too much information is presented to the website visitor all at once. Such a cluttered presentation of multiple or multiple sponsor information may not be the most effective form of advertising, as a typical website visitor may find the excessive number of all sponsors unmemorable.

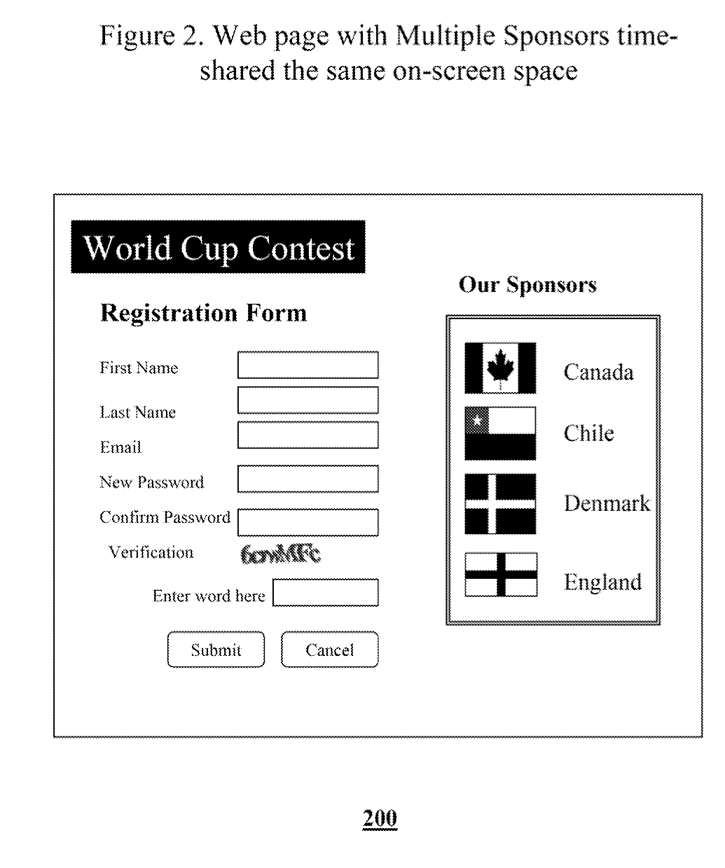

FIG. 2 shows another conventional layout (200) in a joint sponsorship venue, which involves presenting only a subset of all multiple sponsors on a webpage for a particular time slice. For example, one subset may include only four national sponsors (e.g. Canada, Chile, Denmark, and England) from a total of sixteen multiple sponsors. This example may involve four subsets, each subset including four discrete national sponsors, wherein the four subsets use a script program (e.g. Flash) to present all of the subsets sequentially to a website visitor. In one example, a subset may get a certain time interval for presenting itself in a showing window on a webpage, until a next subset rotates into the same showing window using a script program. These subset rotations patterns may be looped and continuous in the same webpage unless the website visitor travels to another webpage.

However, this conventional subset rotation method may still have a problem for a website visitor to recognize all of the multiple sponsors in a short timeframe. It may be especially ineffective if the time spent by the website visitor on the joint sponsorship advertisement page is less than the total time taken to rotate through all of the multiple sponsors.

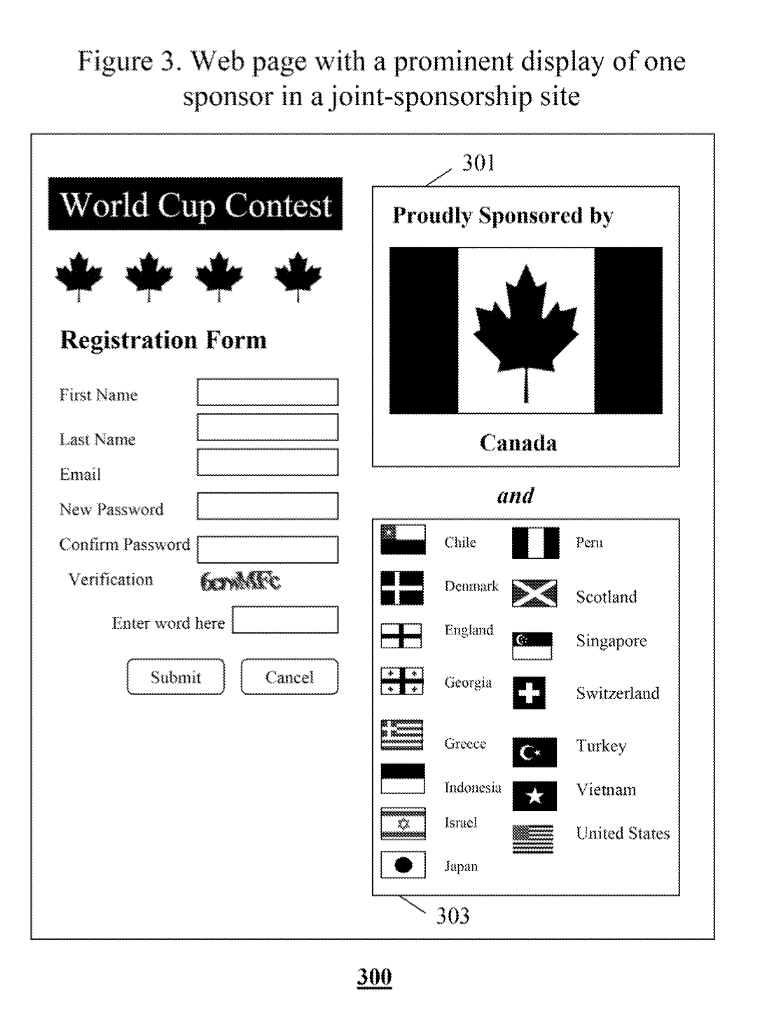

FIG. 3 shows a screenshot (300) from one or more “prominent” sponsorship theme rotation elements (301) in a joint-sponsorship website, in accordance with an embodiment of the invention. In a preferred embodiment of the invention, a “prominent” sponsorship rotation involves zooming-in, focusing on, and/or highlighting a particular sponsor among a plurality of sponsors as separate visual elements (i.e. 301), while keeping non-prominent sponsors in smaller, different, or less-prominent (e.g. by using different color or transparency variations) graphics and/or fonts as non-prominent sponsor elements (303) in the joint-sponsorship website. In the example of FIG. 3, Canada is currently a “prominent” sponsor with its prominent sponsorship theme rotation elements (301) on a webpage while fifteen other countries are listed in smaller graphics and fonts as the non-prominent sponsor elements (303). A website visitor is likely to appreciate this unique two-tiered arrangement in a joint sponsorship campaign, in which a first-tier sponsor (i.e. a prominent sponsor) displays prominent sponsorship theme rotation elements (301), and a second-tier sponsor (i.e. a non-prominent sponsor) displays non-prominent sponsor elements (303), which are typically in smaller sizes than the prominent sponsorship theme rotation elements (301). The concept of a “prominent” sponsor among multiples on a webpage may become an effective branding and marketing tool for sponsor entities. Furthermore, the two-tiered sponsorships may also incorporate a tier rotation method, which changes a currently-second tier sponsor (i.e. a non-prominent sponsor) represented as non-prominent sponsor elements (303) into prominent sponsorship theme rotation elements (301), if the website is refreshed or reloaded by the website visitor.

In order to achieve balanced or even visibility of prominent sponsorship theme rotation elements (301) for each of the multiple number of sponsors, it may be necessary to track the number of prominent sponsorship showings for a particular sponsor to a plurality of website visitors. For example, if each sponsor paid an equal amount of sponsor fees, then each sponsor may be entitled to an equal amount of prominent sponsorship showings for a given number of website visitors. In one embodiment of the invention, if each sponsor has a prominent sponsorship theme designed for the prominent sponsorship theme rotation elements (301) or another similar visual interface, and there are one million visitors and twenty sponsors which are equally funding a joint promotion project, then each sponsor may get to show its own prominent sponsorship theme fifty thousand times to website visitors.

In another embodiment of the invention, if multiple sponsors have different percentages of monetary contribution (i.e. “weighted” sponsorship) to a joint promotion project on a website, then the number of showings to website visitors may be correlated to the percentages of monetary contribution to the joint promotion project. For example, a first sponsor (S1) may pay 20% of the total joint sponsorship fees and eight other sponsors (S2˜S9) may pay an equal amount of 10% each. In this example, the prominent sponsorship theme rotating system may allocate 20% of the website visitors to see the first sponsor's (S1's) prominent sponsorship theme, while allocating 10% of the remaining visitors to each of the eight other sponsors (S2˜S9). In a preferred embodiment of the invention, each sponsor in a weighted sponsorship may receive a correlating weight for a frequency of presentations for its prominent sponsorship theme among a plurality of sponsors.

Furthermore, a website visitor may be referred to a joint sponsorship website via an URL link or another piece of sponsor identifying information in a sponsor's website, an online forum, an online news article, and other venues associated with a particular sponsor. If the website visitor is introduced to the joint sponsorship website through the URL link or another piece of sponsor identifying information associated with the particular sponsor, the prominent sponsorship rotation scheme may not be activated for that referred website visitor in favor of a prominent theme of the particular sponsor.

In a preferred embodiment of the invention, a webpage with a prominent sponsor theme may contain elements of a theme chosen by a prominent sponsor among numerous sponsors. Relevant elements for the prominent sponsor theme may be related to a color theme, a layout theme, display logos, an embedded video, and other items particular to the prominent sponsor. In the preferred embodiment of the invention, a website visitor may enter contact information and submit the contact information to a server to store the registration information in a joint-sponsorship website with registration pages. In this embodiment of the invention, if a next page to be presented in a joint sponsorship website is a registration page relevant to a particular prominent sponsor, then it may be more beneficial to direct the website visitor to the prominent sponsor's own website instead of continuing user interactions through the joint-sponsorship website. Therefore, user interaction with a prominent sponsorship theme may determine subsequent data flow of user data or data entry, in accordance with an embodiment of the invention.

In one embodiment of the invention, a joint-sponsorship website can detect whether a website visitor has visited the website before by tracking cookies, IP addresses, or other identifying pieces of information. If visitor tracking feature is activated in the joint-sponsorship website, the joint-sponsorship website can strategically and intentionally present a prominent sponsorship theme of a sponsor which the visitor has not encountered before. Therefore, a repeat website visitor may see a different prominent sponsor on a rotating basis during each visit, and if the repeat website visitor visits numerous times, then the repeat website visitor may be able to experience all of prominent sponsorship themes covering all participating sponsors.

Furthermore, in one embodiment of the invention, the joint-sponsorship website may be part of an award-based cross promotion (ABCP) campaign, which may motivate a website visitor to interact or participate in the ABCP for the chance of winning an award, such as a prize in a sweepstake funded by multiple sponsors.

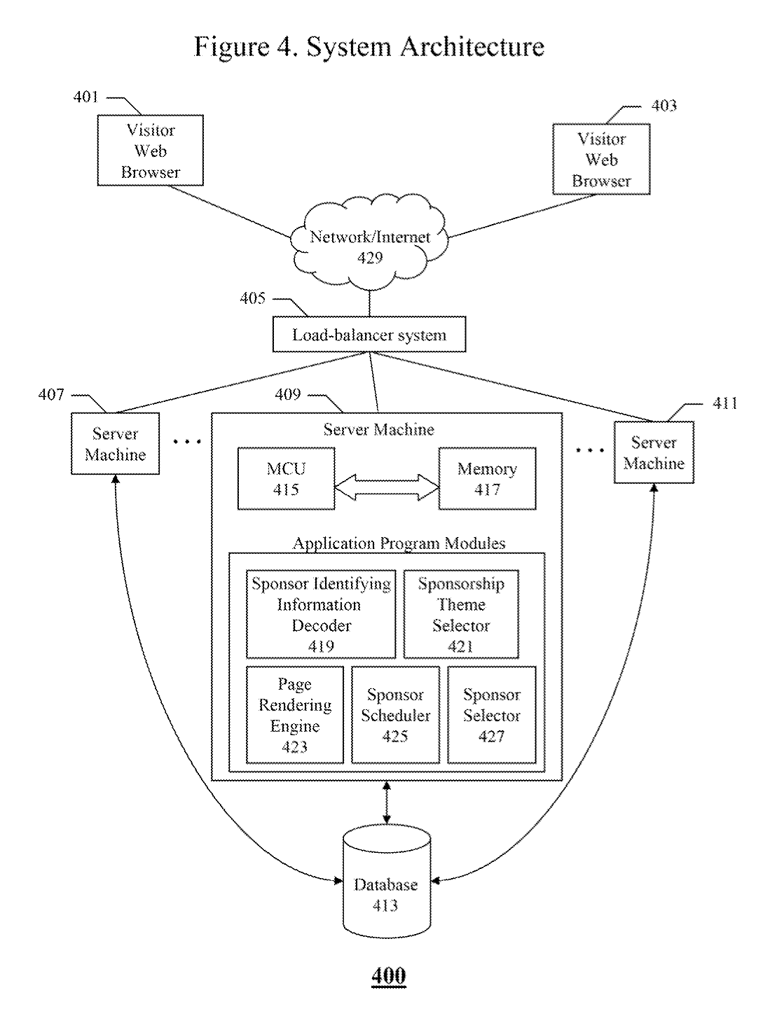

FIG. 4 shows a system architecture of a computerized system (400) for a prominent sponsorship theme rotation in a joint-sponsorship website, in accordance with an embodiment of the invention. In a preferred embodiment of the invention, a computerized system (400) for the prominent sponsorship theme rotation in the joint-sponsorship website comprises at least one server machine (409) which include application program modules (419, 421, 423, 425, 427), a CPU (415), and a memory unit (417). The computerized system (400) also includes a database (413) to store sponsorship-related data and one or more visitor web browsers (401, 403), which are operatively connected to the server machine (409) by a data network (429). In addition, there may be a multiple number of server machines (i.e. 407, 411) which are operatively connected to the computerized system (400). This computerized system (400) may be implemented in a client-server network topology, and website visitors can access and interact with the server machines (i.e. 409, 407, 411) containing application program modules (i.e. 419, 421, 423, 425, 427) for the prominent sponsorship theme rotation via the visitor web browser. Furthermore, a load-balancer system (405) may be optionally used to balance network traffic among different server systems to utilize server resources.

In a preferred embodiment of the invention, the application program module in a server machine (i.e. 409) comprises a sponsor identifying information decoder (419), a sponsorship theme selector (421), a page rendering engine (423), a sponsor selector (427), and a sponsor scheduler (425). In one example of using the computerized system (400) for the prominent sponsorship theme rotation in the joint-sponsorship website, a website visitor may come to visit the joint-sponsorship website through a URL or another sponsor identifying information. In one embodiment of the invention, the visitor may type the URL or another sponsor identifying information directly into a web browser. In another embodiment of the invention, the visitor may click or activate a web link from another website. Furthermore, the sponsor identifying information decoder in the server machine (e.g. 409) of the computerized system (400) for a prominent sponsorship theme rotation in a joint-sponsorship website can examine the syntax of the URL or another sponsor identifying information to determine whether the URL or another sponsor identifying information embeds any sponsor information.

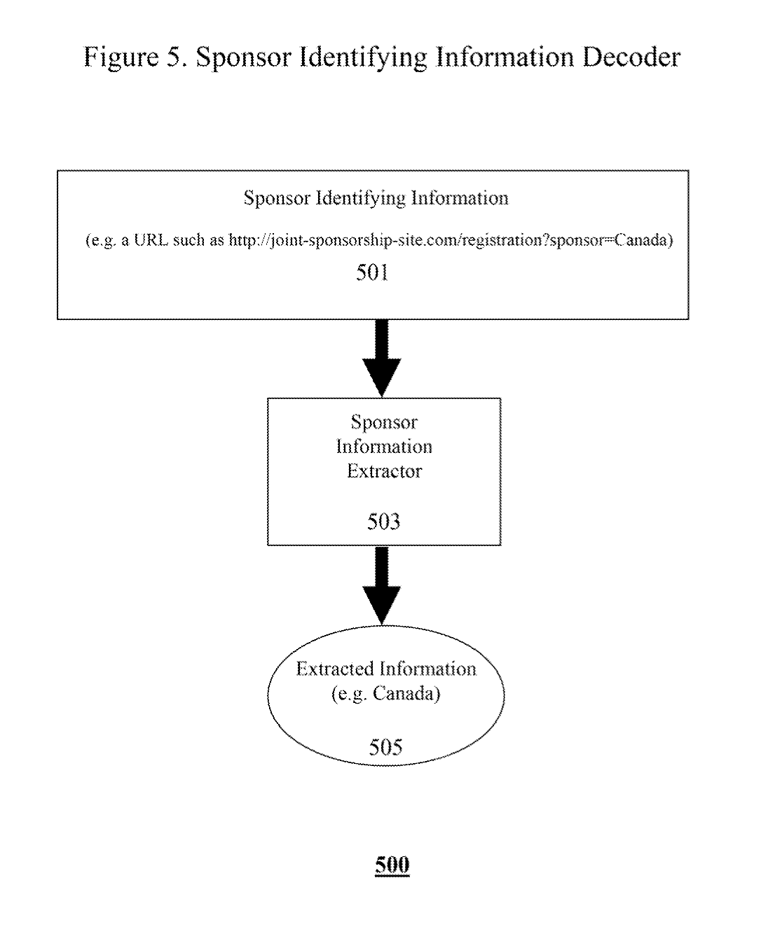

FIG. 5 shows a sponsor identifying information decoder (500) for a computerized system operating a prominent sponsorship theme rotation in a joint-sponsorship website, in accordance with an embodiment of the invention. As shown in FIG. 5, in a preferred embodiment of the invention, an example of the sponsor identifying information decoder (500) uses a sponsor information extractor (503) to extract specified sponsor information from sponsor identifying information (501), such as a URL. In this particular example, the sponsor identifying information (501) contains information associated with the term “Canada”. Typically, the format of how the sponsor information is encoded in sponsor identifying information (e.g. a URL) is pre-determined, and the sponsor identifying information decoder (500) has a pre-determined algorithm or method to decode the sponsor identifying information (e.g. a URL) (501) to extract the specified sponsor information. As shown in FIG. 5, the sponsor information extractor (503) is able to generate the extracted information (505), which is the term “Canada” from the sponsor identifying information (501) in this particular example.

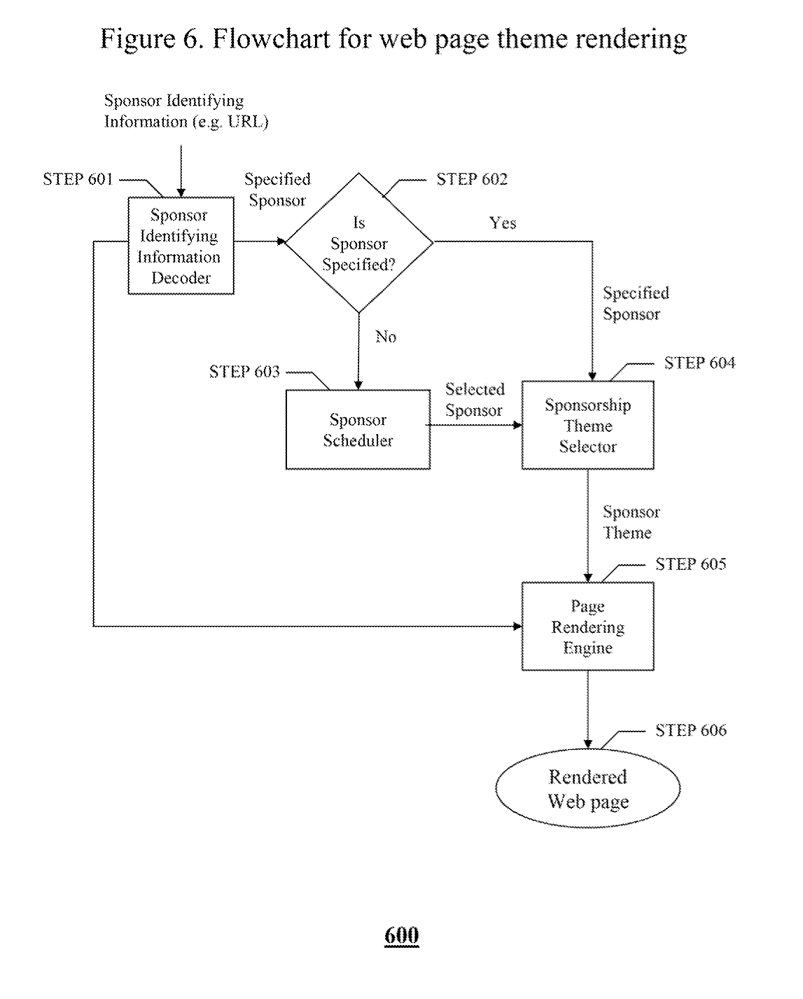

FIG. 6 shows a flowchart (600) for a webpage rendering engine of a computerized system (600) operating a prominent sponsorship theme rotation in a joint-sponsorship website, in accordance with an embodiment of the invention. This flowchart (600) shows how sponsor identifying information (e.g. a URL) can lead to a rendered webpage for a website visitor. In one embodiment of the invention, as shown in STEP 601 and STEP 602, a sponsor identifying information decoder determines whether any sponsor information is embedded in the sponsor identifying information. If there is some sponsor information embedded in the sponsor identifying information, a sponsorship theme selector is informed of a specified sponsor, as shown in STEP 604. In contrast, if there is no embedded sponsor information specified, a sponsor scheduler is invoked to choose a sponsor based on the visiting history of the website visitor, as shown in STEP 603. Once a sponsor is selected, a sponsor theme can be determined by mapping the selected sponsor in a sponsorship theme mapper, as shown in STEP 604. Then, a page rendering engine takes the content of the original sponsor identifying information (e.g. an original URL) and the selected sponsor theme (i.e. STEP 605) to render a webpage (i.e. STEP 606), which is transmitted or delivered to a web browser used by the website visitor.

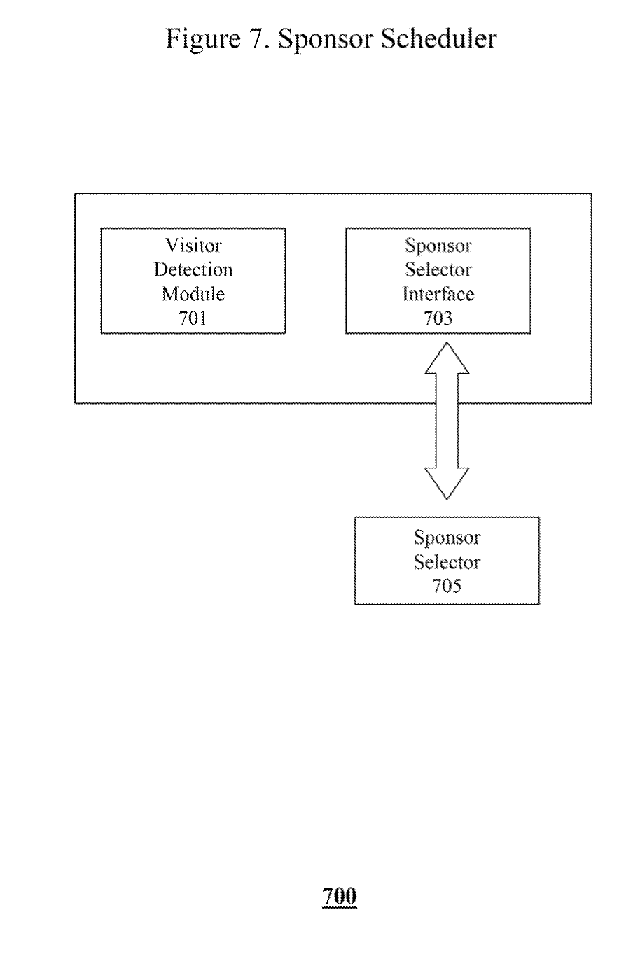

FIG. 7 shows an example of a sponsor scheduler (700) for a computerized system operating a prominent sponsorship theme rotation in a joint-sponsorship website, in accordance with an embodiment of the invention. In a preferred embodiment of the invention, the sponsor scheduler (700) is configured to analyze, maintain, and/or process website visitor-related information, including a record of visitor history for at least some website visitors. The visitor history may be maintained by accessing cookies of a web browser of a website visitor, or by tracking IP addresses or session layers for a particular website visitor.

As shown in FIG. 7, the sponsor scheduler (700) comprises a visitor detection module (701) and a sponsor selector interface (703). The sponsor scheduler (700) is also operatively connected to a sponsor selector (705). In one embodiment of the invention, the visitor detection module is able to detect, track, and maintain records related to at least some website visitors. If the computerized system operating a prominent sponsorship theme requests the sponsor scheduler (700) to select one of the prominent sponsorship themes among multiple sponsors based on a website visitor's past visiting history, then the visitor detection module is able to analyze, maintain, and/or process the website visitor-related information and recommend a particular prominent sponsorship theme by sending relevant information through the sponsor selector interface.

In one embodiment of the invention, the sponsor scheduler tracks a website visitor's web browser visits to a joint-sponsorship website and the number of showings for a particular prominent sponsorship theme by storing information in a cookie file, a history file, an information tracking file, an identification code associated with the website visitor's web browser, an identification code associated with the visitor's computer, and/or by maintaining a visitor/sponsor map on the server.

Information stored on the website visitor's computer may be coordinated by the visitor detection module (701) in the sponsor scheduler (700) as an application program module operating on a server operatively connected to a website visitor's browser. This server can access the website visitor-related information when the website visitor's browser requests connection with the server. For example, the website visitor-related information can be stored in a text file in the visitor's computer as a cookie file associated with the visitor's web browser. In one embodiment of the invention, if the website visitor-related information is not stored in the visitor's computer, it may be assumed that the website visitor has not visited the website before.

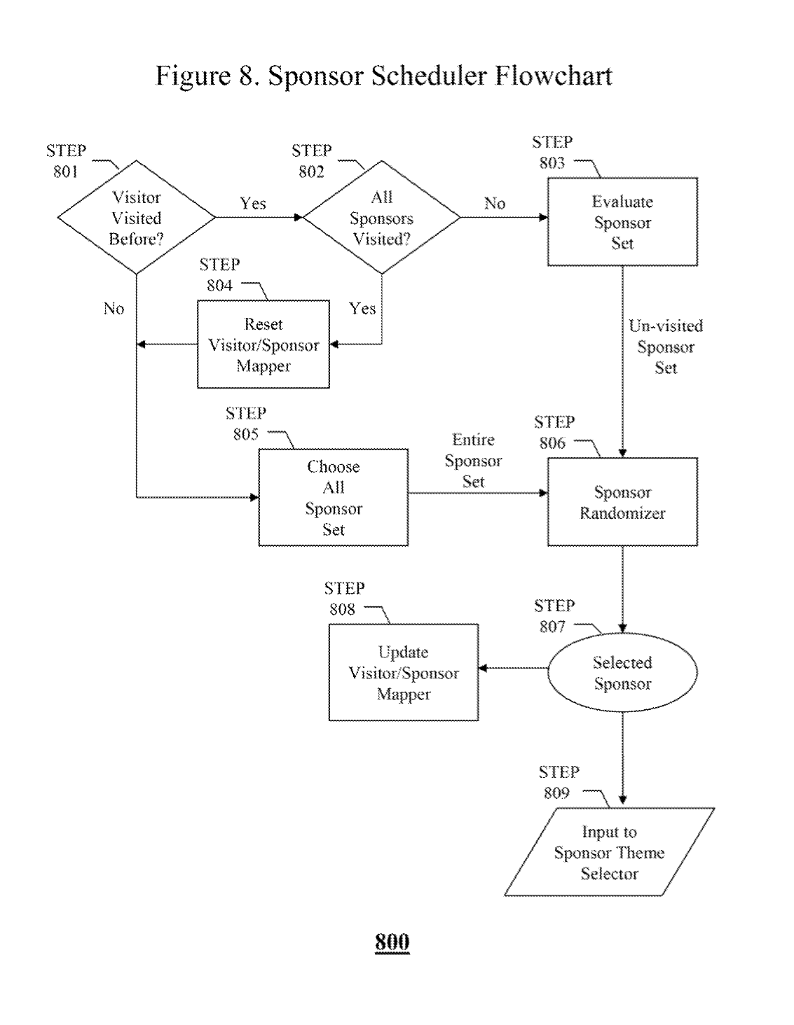

FIG. 8 shows a sponsor scheduler flowchart (800) for a computerized system operating a prominent sponsorship theme rotation in a joint-sponsorship website, in accordance with an embodiment of the invention. In a preferred embodiment of the invention, if a website visitor visited a joint-sponsorship website and have seen all of the prominent sponsorship themes by all sponsors, as shown in STEPs 801 and 802, then a visitor/sponsor mapper is reset to choose all sponsor set (i.e. STEP 804), from which a random selection occurs for a subsequent prominent sponsorship theme showing. If, on the other hand, the website visitor visited the joint-sponsorship website and have not seen all of the prominent sponsorship themes by all sponsors (i.e. STEP 802 and STEP 803), then the sponsor scheduler can identify unvisited sponsor set, from which a random selection occurs among from the unvisited sponsor set, as shown in STEP 803 and STEP 806. In both cases, the visitor/sponsor mapper can be updated after a particular sponsor is selected for future evaluation of sponsor sets and future selection of another prominent sponsorship theme.

In addition, if a website visitor never visited the joint-sponsorship website before (i.e. STEP 801 and STEP 805), then typically, a random selection occurs from all sponsor set for a particular prominent sponsorship theme showing, as shown in STEPs 805 and 806. The visitor/sponsor mapper can be also updated for website visitor-related information, as shown in STEP 808. For example, a first-time website visitor can be recognized as a repeat visitor during his/her subsequent visit to the joint-sponsorship website with the update to the visitor/sponsor mapper update. Furthermore, in a preferred embodiment of the invention, a sponsor theme selector receives information related to a selected sponsor (i.e. STEP 807) as an input value to choose a sponsor theme corresponding to the selected sponsor, as shown in STEP 809.

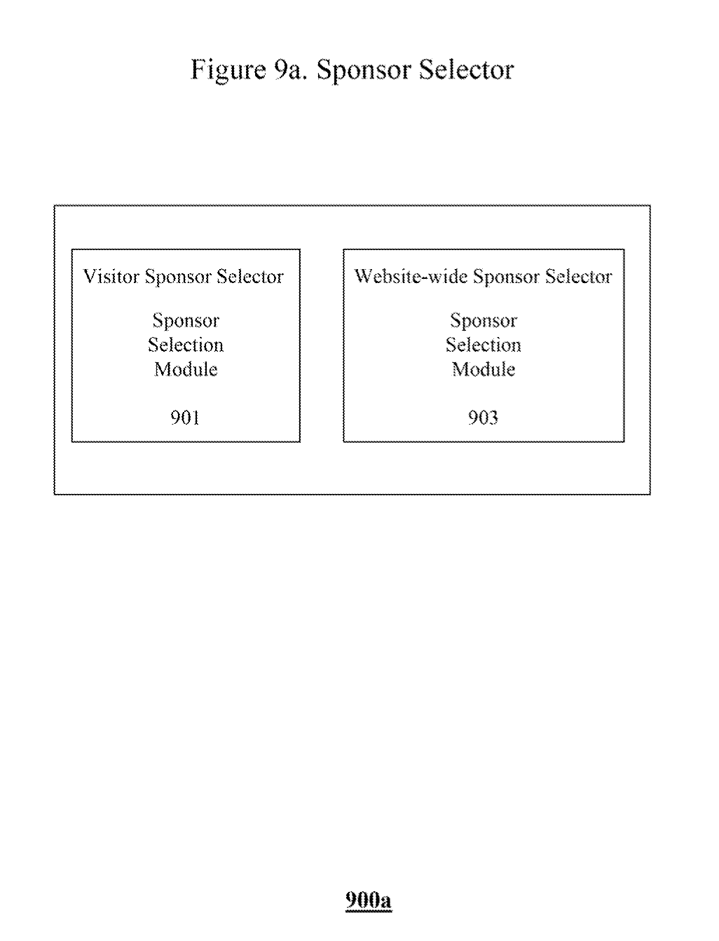

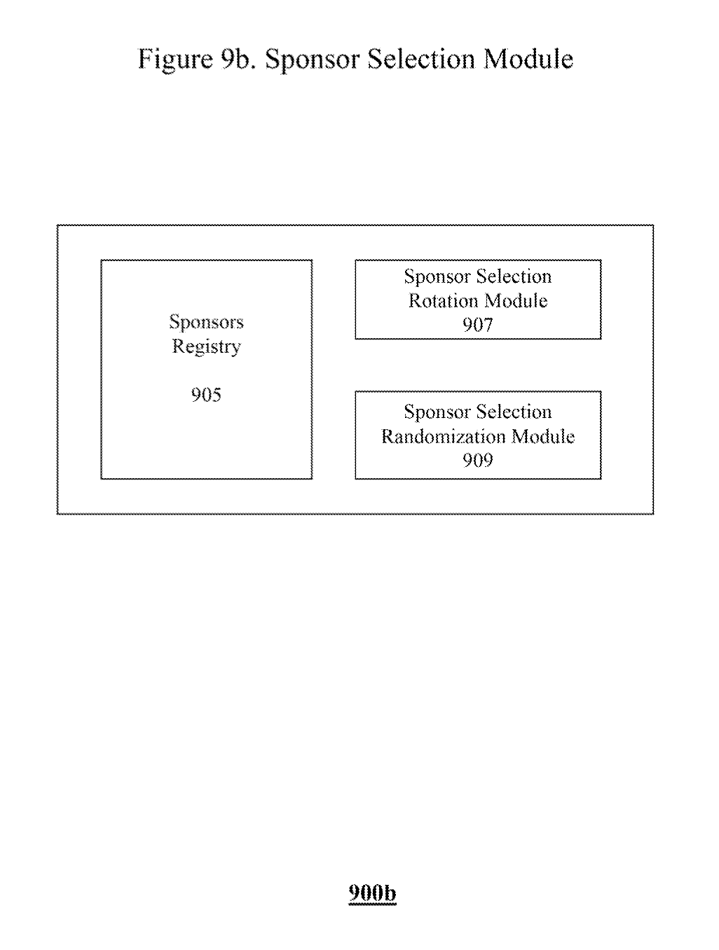

FIG. 9a shows a sponsor selector (900a) for a computerized system operating a prominent sponsorship theme rotation in a joint-sponsorship website, in accordance with an embodiment of the invention. In one embodiment of the invention, the sponsor selector comprises a visitor sponsor selector (901) and a website-wide sponsor selector (903). The visitor sponsor selector (901) and the website-wide sponsor selector (903) may contain their own sponsor selection modules. The visitor sponsor selector (901) may track repeat visitors, while website-wide sponsor selector (903) may track first time visitor. In one embodiment of the invention, the visitor/sponsor map may contain the following information:

| | Pre-defined | |
|---|---|---|
| Sponsor | Sponsor Weight | Current Weight |
| S₁ | W1 | |
| S₂ | W2 | |
| . | . | |
| . | . | |
| . | . | |
| Sₙ | Wn | |

In this embodiment of the invention, each sponsor (S₁˜Sₙ) may have pre-defined sponsor weights which may be proportional to financial contribution amounts by each sponsor. The pre-defined sponsor weight represents the probability of showing a prominent sponsorship theme of a particular sponsor to website visitors. For example, a joint sponsorship may contain 6 sponsors, and Sponsor S1 and Sponsor S2 bear 30% of the total sponsorship amount each, while Sponsor S3 to Sponsor S6 bear 10% of the total sponsorship amount each. In this scenario, it is pre-determined to serve 30% of all visitors to a first prominent sponsorship theme for S1, 30% of all visitors to a second prominent sponsorship theme for S2, and 10% of all visitors to prominent sponsorship themes for each of the remaining sponsors (S3˜S6).

When a visitor, Vi, first visits the joint-sponsorship website, the Visitor/Sponsor Map for Vi may initially contain the following information:

| | Pre-defined | |
|---|---|---|
| Sponsor | Sponsor Weight | Current Weight |
| S₁ | 30% | 30% |
| S₂ | 30% | 30% |
| S₃ | 10% | 10% |
| S₄ | 10% | 10% |
| S₅ | 10% | 10% |
| S₆ | 10% | 10% |

In another embodiment of the invention, an effective way to enforce a weighting method may be assigning a counter to each sponsor (per visitor, V1˜Vn) in the joint-sponsorship, wherein the counter corresponds to the pre-defined sponsor weight. The counter, as the term suggests, is generally an integer number. As a particular visitor (V1) visits the joint sponsorship website and is shown a particular prominent sponsorship theme, the counter corresponding to that prominent sponsorship theme is decreased by 1. If a particular counter reaches zero, a prominent sponsorship theme corresponding to that counter is no longer shown to that particular visitor. This iterative process can continue until all counters have integer values of zero, at which point all counters can be re-set to the initial pre-defined sponsor weight proportions, or a new proportion if the visitor detection module of the sponsor scheduler instructs the sponsor selector.

FIG. 9b shows an example of a sponsor selection module (900b) for a computerized system operating a prominent sponsorship theme rotation in a joint-sponsorship website, in accordance with an embodiment of the invention.

In this embodiment of the invention, a sponsors registry (905) can keep track of all sponsors and a history of the selected sponsors for a jointly sponsored website. The sponsor selection rotation module (907) is configured to select a sponsor from the sponsors registry based on a defined theme of rotation. Furthermore, the sponsor selection randomization module (909) selects a sponsor from the sponsors registry based on a random theme.

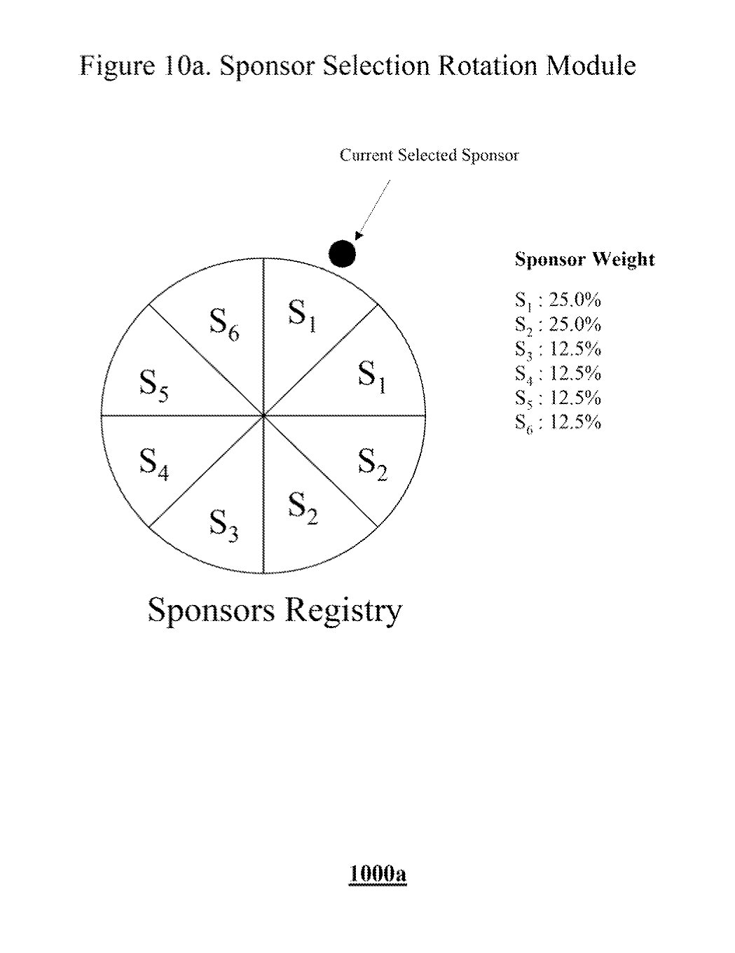

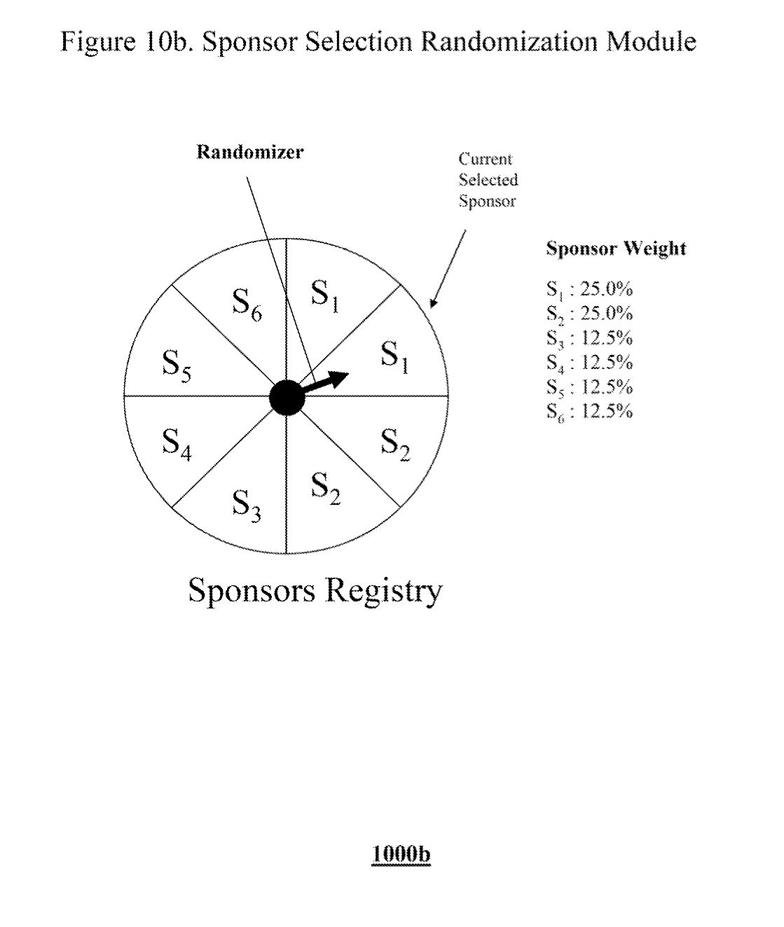

FIG. 10a shows a graphical representation (1000a) of a sponsor selection rotation module for a system operating a prominent sponsorship theme rotation in a joint-sponsorship website, in accordance with an embodiment of the invention.

The graphical representation (1000a) of FIG. 10a illustrates a sample sponsorship with 6 sponsors (S1˜S6), with Sponsor 1 and Sponsor 2 representing 25% of weighted share per sponsor for the joint sponsorship shares, and Sponsors 3, 4, 5, and 6 representing 12.5% for the joint sponsorship shares per sponsor. In this particular example, the rotation theme is configured to select a prominent sponsorship theme of a particular sponsor in a clockwise direction.

FIG. 10b shows a weighted randomization module for a graphical representation (1000b) of a sponsor selection rotation module, in accordance with an embodiment of the invention.

The graphical representation (1000b) of FIG. 10b illustrates a sample sponsorship with 6 sponsors, with Sponsor 1 and Sponsor 2 representing 25% of weighted share per sponsor for the joint sponsorship shares, and Sponsors 3, 4, 5, and 6 representing 12.5% for the joint sponsorship shares per sponsor. A “randomizer” is shown as a rotating arrow to represent a random selection of a sponsor for its prominent sponsorship theme from a sponsors registry.

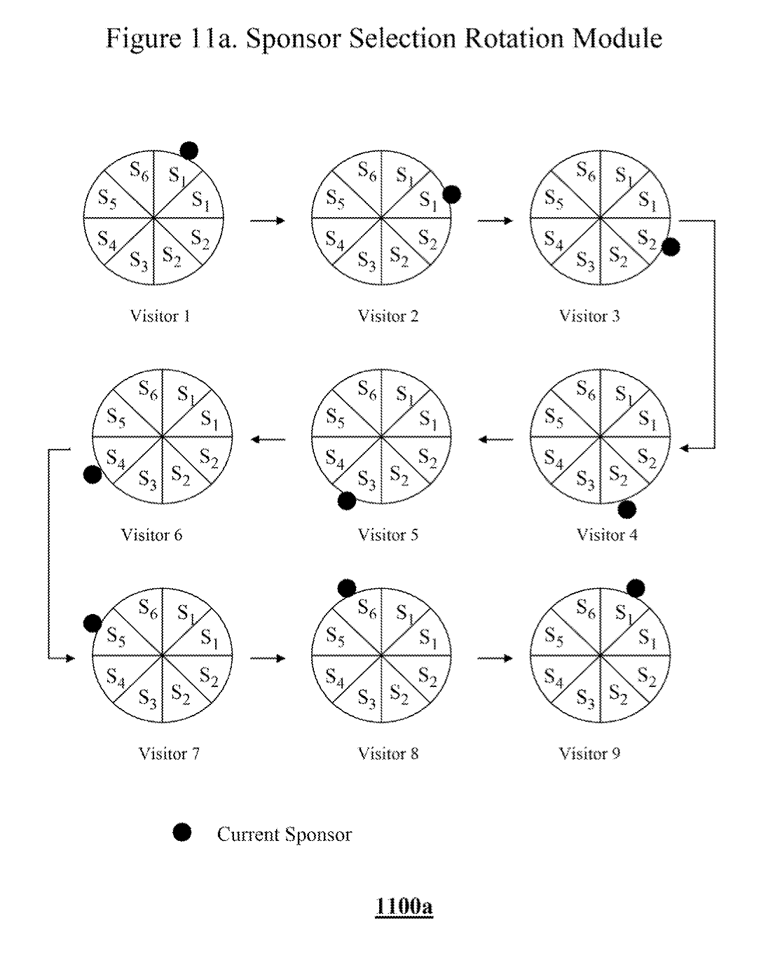

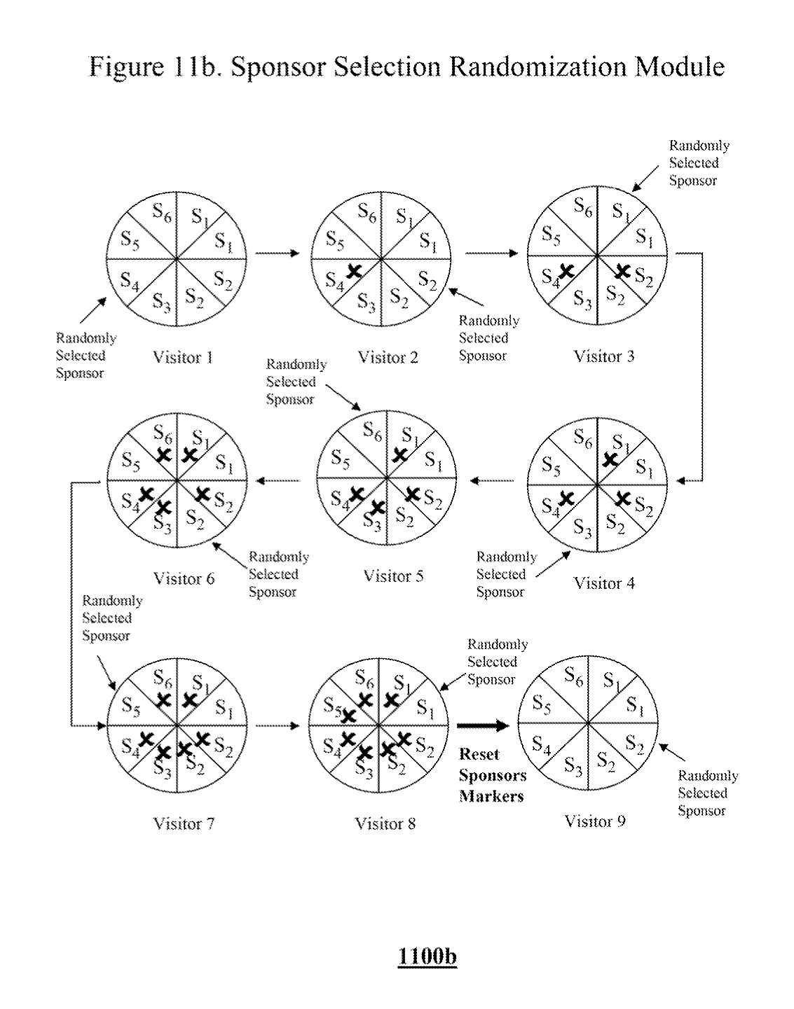

FIG. 11a shows a graphical representation (1100a) of multiple visitors with weighted sponsor ratios for a sponsor selection rotation module used to display a prominent sponsorship theme of a particular sponsor to each visitor, in accordance with an embodiment of the invention. This graphical representation (1100a) illustrates how a sponsor is selected based on a rotation theme of a sponsor selection rotation module from the sponsors registry, in accordance with an embodiment of the invention. For example, Sponsor 1 (S1) is selected for Visitor 1, and is selected again for Visitor 2 for prominent sponsorship theme display, according to the a clockwise rotation selection theme with sponsor weight ratios as previously described in FIG. 10a and FIG. 10b. In the same example, Sponsor 2 (S2) is selected for Visitor 3, and is selected again for Visitor 4. Then, other sponsors (S3˜S6) with less sponsor weight ratios (e.g. 12.5% instead of 25% for each of S1 and S2, as shown in FIG. 10a and FIG. 10b) may be selected for prominent sponsorship theme display, as more visitors visit the joint-sponsorship website. For a repeat visitor to the joint-sponsorship website, the method of displaying different prominent sponsorship themes may be similar to that of discrete visitors, with display ratios of prominent sponsorship themes corresponding to the sponsor weight ratios configured and determined by the sponsors registry and/or the computerized system operating a prominent sponsorship theme rotation in the joint-sponsorship website.

FIG. 11b shows a graphical representation (1100b) of multiple visitors with weighted sponsor ratios and randomization for a sponsor selection randomization module, which takes account of both weighted sponsor ratios and randomizations to display a prominent sponsorship theme of a particular sponsor to each visitor, in accordance with an embodiment of the invention.

In this embodiment of the invention, a sponsor is selected based on a random selection theme from the sponsors registry. For example, Sponsor 4 (S4) is selected randomly from the sponsors registry for Visitor 1 while also observing the weighted sponsor ratios per sponsor, and is then marked “visited.” Then, Sponsor 2 (S2) is selected for Visitor 2 from the un-visited sponsor, and is marked ‘visited’ after being selected. In this embodiment of the invention which observes both weighted sponsor ratios and randomization, the sponsor selection process and visitor marking may continue until shares of all sponsors are selected and marked “visited.” After all sponsors' prominent sponsorship themes are marked as “visited,” the sponsors registry may be reset to an unmarked state, with all sponsors (S1˜S6) cleared by visitor marks for another round of sponsor weight ratio-based randomized sponsor selection for prominent sponsorship theme display.

Various embodiments of the present invention may provide several advantages over conventional representations of multiple sponsor entities in a website. First, various embodiments of the present invention enable a website visitor to recognize all of the sponsors in a short timeframe with one visual inspection, while allowing the website visitor to also focus his/her attention to a particular sponsor with a prominent sponsorship theme display. For a website funded and/or supported by a multiple sponsor entities, this unique presentation of multiple sponsor themes may be more memorable and effective than conventional methods. Furthermore, by enabling the prominent sponsorship theme display to be either weighted, randomized, or both, various embodiments of the present invention enable flexible and/or variable amount of funding for sponsorship-related advertisement for a joint-sponsorship website. In addition, various embodiments of the present invention also enable a prominent sponsorship theme to be optimized for each website visitor's individual characteristics (e.g. taking account of an origin of sponsor identifying information (e.g. an URL) utilized to reach the joint-sponsorship website) to present a personalized and effective sponsorship-driven advertisement per website visitor.

Moreover, various embodiments of the present invention can also be utilized to display a prominent sponsorship theme of one selected sponsor and non-prominent sponsorships (i.e. list of non-prominent sponsors) of other sponsors on a single user interface screen for an award-based cross promotion (ABCP) campaign (e.g. a jointly-sponsored sweepstake with a prize for participants). The presentation of the prominent sponsorship theme of a selected sponsor and the remaining sponsorships of non-prominent sponsors in a single user interface screen may provide a more memorable and effective advertising impact on the ABCP participants.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A computerized system operating a prominent sponsorship theme rotation in a joint-sponsorship website, the computerized system comprising:
a server machine operatively connected to a data network, wherein the server machine comprises a CPU, a memory unit, and an application program module comprising a sponsor identifying information decoder, a sponsorship theme selector, a page rendering engine, and a sponsor scheduler, wherein the application program module is executable on the CPU and the memory unit;
a database operatively connected to the server machine, wherein the database is configured to store at least one of website-related, sponsor-related, and website visitor-related information;
a sponsor selector operatively connected to or contained in the server machine, wherein the sponsor selector is capable of choosing a particular prominent sponsorship theme for a particular sponsor among a plurality of sponsors; and
a website visitor's web browser operatively connected to the computer network.

2. The computerized system of claim 1, wherein the sponsor identifying information decoder comprises a sponsor information extractor unit, which takes a piece of sponsor identifying information as an input and generates extracted information associated with the sponsor identifying information as an output.

3. The computerized system of claim 1, wherein the sponsor selector comprises a visitor sponsor selector containing a sponsor selection module and a website-sponsor selector containing another sponsor selection module.

4. The computerized system of claim 3, wherein each sponsor selection module comprises a sponsors registry, a sponsor selection rotation module, and a sponsor selection randomization module.

5. The computerized system of claim 4, wherein the sponsors registry keeps track of prominent sponsorship theme selection per sponsor and its related history.

6. The computerized system of claim 1, wherein the sponsor scheduler comprises a visitor detection module and a sponsor selector interface operatively communicating with the sponsor selector.

7. The computerized system of claim 1, wherein the sponsorship theme selector takes a selected sponsor from the sponsor scheduler or a specified sponsor from the sponsor identifying information decoder, and generates the particular prominent sponsorship theme for the particular sponsor among the plurality of sponsors.

8. The computerized system of claim 1, wherein the page rendering engine takes the particular prominent sponsorship theme generated by the sponsorship theme selector and an output from the sponsor identifying information decoder to generate a rendered webpage.

9. The computerized system of claim 4, wherein the sponsor selection rotation module utilizes a sponsor weight ratio per sponsor to select and present a prominent sponsorship theme of a sponsor to the website visitor's web browser according to the sponsor weight ratio.

10. The computerized system of claim 4, wherein the sponsor selection randomization module contains a randomizer to randomize selection of a prominent sponsorship theme while also obeying a sponsor weight ratio per sponsor, wherein the prominent sponsorship theme selected by the sponsor selection randomization module is presented to the website visitor's web browser.

11. The computerized system of claim 1, wherein the website visitor's web browser displays one or more prominent sponsorship theme rotation elements and one or more non-prominent sponsor elements.

12. The computerized system of claim 11, wherein the one or more prominent sponsorship theme rotation elements display the particular prominent sponsorship theme for the particular sponsor among the plurality of sponsors, and wherein the one or more non-prominent sponsor elements display all sponsors other than the particular sponsor.

13. The computerized system of claim 1, wherein the joint-sponsorship website incorporates an award-based cross promotion (ABCP) campaign.

14. A method of enabling a prominent sponsorship theme rotation in a joint-sponsorship website, the method comprising the steps of:
taking a piece of sponsor identifying information in a sponsor identifying information decoder of an application program module executable on a CPU and a memory unit of a computerized system, wherein the sponsor identifying information decoder generates extracted information;
determining whether the extracted information from the sponsor identifying information decoder has a specified sponsor; and
if the specified sponsor is found from the extracted information:
using a sponsorship theme selector of the application program module to generate a first prominent sponsor theme for the specified sponsor;
rendering a first webpage which incorporates the first prominent sponsor theme for the specified sponsor; and
presenting the first webpage to a web browser of the joint-sponsorship website;
else if the specified sponsor is not found from the extracted information:
using a sponsor scheduler and a sponsor selector of the application program module to select a particular sponsor;
using the sponsorship theme selector of the application program module to generate a second prominent sponsor theme for the particular sponsor;
rendering a second webpage which incorporates the second prominent sponsor theme for the particular sponsor; and
presenting the second webpage to the web browser of the joint-sponsorship website.

15. The method of claim 14, further comprising a step of displaying one or more non-prominent sponsor elements on the first webpage or the second webpage, wherein the one or more non-prominent sponsor elements incorporate sponsors not currently selected for the first prominent sponsor theme or the second prominent sponsor theme.

16. The method of claim 14, wherein the joint-sponsorship website incorporates an award-based cross promotion (ABCP) campaign.
